(19) United States
(12) Patent Application Publication
(10) Pub. No.: US 2023/0121223 A1
(43) Pub. Date: Apr. 20, 2023

(54) A Novel Single Hybrid Airlift Bioreactor for Wastewater Treatment

(71) Applicants: Mohammad Tofigh Rayhani, Ottawa (CA); Ali Akbar Zinatizadeh, Ottawa (CA); Mahsa Mirghorayshi, Ottawa (CA); Hossein Bonakdari, Ottawa (CA)

(72) Inventors: Mohammad Tofigh Rayhani, Ottawa (CA); Ali Akbar Natizadeh, Ottawa (CA); Mahsa Mirghorayshi, Ottawa (CA); Hossein Bonakdari, Ottawa (CA)

(21) Appl. No.: 17/914,326

(22) PCT Filed: Nov. 30, 2021
(86) PCT No.: PCT/CA2021/051707

§ 371 Date: Sep. 24, 2022

Related U.S. Application Data
(60) Provisional application No. 63/119,257, filed on Nov. 30, 2020.

(51) Int. Cl. C02F 3/22; C02F 3/30; C02F 1/44

(52) U.S. Cl. CPC C02F 3/223; C02F 3/301; C02F 1/444; C02F 2103/327

(57) ABSTRACT

The disclosure provides a compact and high-rate bioreactor for wastewater treatment comprising a feeding port for introducing a feed of waste material, a reaction zone in liquid communication with the feed port when the bioreactor is in operation and having an aerator to provide an airlift configuration in the reaction zone; a settling zone comprising a separator for separating a liquid effluent from solid particles; a liquid effluent outlet port for withdrawing the liquid effluent; and a solids outlet port for removing solids. Further provided is a spiral separator for use in a bioreactor and a system comprising the bioreactor and a membrane separator to provide hygienic water.

### TECHNICAL FIELD

The disclosure relates to a bioreactor for the treatment of different types of wastewaters, including those containing refractory pollutants such as petrochemical, pharmaceutical, leachate, and slaughter-house wastewaters.

### BACKGROUND

With the rapid population growth and accelerated urbanization and industrialization, municipal wastewater generation has increased dramatically. Municipal wastewater effluents are the largest single effluent discharges, by volume, in Canada. Municipal wastewater consists of sanitary sewage from homes, businesses, industries and institutions, as well as the rain and melted snow that drain into sanitary sewers. Municipal wastewater typically contains human and other organic waste, nutrients, pathogens, microorganisms, suspended solids and household and industrial chemicals. There are many types of industrial wastewaters based on different industries. The effluents of these industries may contain refractory organic compounds and need to undergo pretreatment before they are sent to a municipal wastewater treatment plant.

Municipal effluent has a complex composition including a high content of oxidizable organic matters, nutrients (N and P) and dissolved and suspended solids (SS). Due to stringent regulations enacted for discharge of municipal effluents into receiving waters, it is vital that this wastewater be properly managed to protect public health, preserve our waterways and provide a clean environment for future generations. Depending on the final use of the water (drinking, recreation, irrigation, etc.), several technologies can apply to remove pollutants. Among them, biological wastewater treatment systems rely on the use of microorganisms. The unique abilities of microbes to degrade organic matter, remove nutrients and transform toxic compounds into harmless products make them essential for wastewater removal. An ideal wastewater treatment possesses effortless operation and is low cost.

However, simultaneous removal of organic carbonaceous and nutrients compounds through conventional biological treatment systems, especially from high organic load and nutrient-rich wastewaters has proven challenging. High-rate systems are characterized by small reactor volumes, high concentrations of microorganisms as well as short hydraulic retention times (HRT) compared with low-rate processes. Recent research interests have been in treating industrial wastewaters in a single high-rate bioreactor to meet the strict constraints with respect to space, view and costs.

Operating under different dissolved oxygen (DO) conditions provided by intermittent aeration is a practical strategy for simultaneous CNP removal. Physical separation is another approach that has been attempted to obtain the integrated high-rate bioreactors by combining anaerobic and aerobic processes in separate zones to treat various wastewaters, such as a bubble column with a draught tube, a simultaneous aerobic/anaerobic (SAA) bioreactor, a radial anaerobic/aerobic immobilized biomass (RAAIB) bioreactor, a jet loop membrane bioreactor (JLMBR), and an airlift bioreactor.

Simultaneous nitrification-denitrification (SND) is a well-established alternative technology, whereby two microbial reactions occur concurrently in a single compartment by controlling the dissolved oxygen (DO) concentrations. The hydraulic regime of bioreactors plays a vital role in the removal efficiency. To date, many single bioreactors have been reported using SND for the treatment of different wastewaters. Despite the advantages of SND as an alternative process, the need for an external electron donor (carbon source) in the denitrification step will remain a major challenge for high-efficient SND, especially when wastewater has a low carbon-to-nitrogen ratio C/N.

The advent and development of an anaerobic ammonium oxidation process, namely Anammox™ has revolutionized the concept of biological nitrogen removal from ammonium-rich and carbon-poor wastewaters. The hydraulic regime of bioreactors also plays a vital role in the removal efficiency. The most widely used reactor for SND and Anammox™ nitrogen removal is a sequencing batch reactor (SBR) because it enables the formation of the alternate aerobic and anoxic conditions in a time sequence manner. However, SBR is a kind of intermittent flow reactor that is not appropriate for continuous flow wastewater treatment. In addition, the full-scale application of SBR technology is still problematic due to the complexity of its operation.

Conventional secondary clarifiers require large areas and are not able to remove all small particles. Ensuring the sludge retention time (SRT) is of relatively long duration is also a prerequisite for efficient SND and necessary for anammox nitrogen removal. This is because the growth rate of nitrifiers and anammox bacteria is very slow.

Thus, there is a need in the art for a highly efficient wastewater treatment reactor to prolong the SRT required for adequate nitrogen removal through different pathways.

The present disclosure seeks to address the shortcomings in the art and/or to provide useful alternatives to known multi-stage methods for biological wastewater treatment and sludge separation.

### SUMMARY

The present disclosure provides a hybrid airlift/settling bioreactor (e.g., HALBR) to treat municipal, industrial or other wastewaters, such as those containing refractory organic compounds with different BOD/COD and COD/N ratios. Embodiments disclosed herein provide an approach for modifying the performance of the airlift design for achieving a significantly more complete wastewater treatment (CNP removal) than known reactor designs through taking advantages of different redox conditions, and a method for in-situ biomass separation in a single structure. This modified compact bioreactor is suited for treating a wide variety of wastewaters. For example, the disclosed bioreactor is especially suited for wastewaters containing slowly biodegradable organic matter, such as composting leachate, dairy, and livestock wastewater.

In one embodiment, the bioreactor is equipped with an innovative internal rotatable spiral settler that can provide for the simultaneous removal of carbon and nutrients from wastewater and water reuse. Reactor designs disclosed herein may provide for ease of operation as well as economic feasibility. The bioreactor is designed in certain embodiments to operate continuously, whereby carbon and nutrients are removed in a single stage with different zones in terms of DO concentrations provided by physical separation. The treated effluent from the spiral separator is discharged continuously and may pass through a membrane module, such as an ultrafiltration membrane in a cross-flow membrane configuration to produce hygienic water. In certain embodiments, the invention overcomes the drawbacks of certain known systems by providing a high-rate hybrid and single-stage system that can be installed within existing conventional wastewater treatment plants and may offer treatment of a wide range of wastewaters at a lower cost and/or smaller footprint. The bioreactor in embodiments disclosed herein combines different redox conditions (e.g., anaerobic/anoxic/aerobic) in a single bioreactor together with employing an internal rotating spiral separator as a solution to enhance biodegradation and the efficiency of carbon and nutrients removal from wastewater. The disclosed bioreactor results in economic benefits due to removing the need for a secondary clarifier, maximizing the sludge retention time (SRT), and enabling lower construction costs. According to one aspect of the disclosure, there is provided a bioreactor for waste treatment comprising a feeding port for introducing a feed of waste material, a reaction zone in liquid communication with the feed port when the bioreactor is in operation and having an aerator to provide an airlift configuration in the reaction zone; a settling zone comprising a separator for separating a liquid effluent from a suspended biomass by settling; a liquid effluent outlet port for withdrawing the liquid effluent; and a sludge wasting pump for removing excess biomass.

In one embodiment of the foregoing aspect, the feed of waste introduced to the bioreactor is a wastewater that is selected from: pharmaceutical, petrochemical, food processing, and composting leachate wastewater.

According to another embodiment of the foregoing aspect or embodiment, the bioreactor further comprises a pretreatment zone in a bottom region thereof for accommodating microaerobic or anaerobic conditions and for solubilizing micro-molecules into smaller molecules thereof via hydrolysis and/or acidification.

According to another embodiment of the foregoing aspect or any embodiment thereof, the feeding port is located at a bottom of the bioreactor, and optionally a further second feeding port is disposed in an anoxic part of the bioreactor to allow availability of substrate for micro flora attached therein and for introducing anoxic conditions thereof.

According to another embodiment of the foregoing aspect or any embodiment thereof, the bioreactor comprises different nitrogen removal pathways.

According to another embodiment of the foregoing aspect or any embodiment thereof, the separator in the settling zone is a spiral separator.

According to another embodiment of the foregoing aspect or any embodiment thereof, the spiral separator is rotatable.

According to another embodiment of the foregoing aspect or any embodiment thereof, the airlift configuration in the reaction zone is in a middle region of the bioreactor and the settling zone is in a top region of the bioreactor.

According to another embodiment of the foregoing aspect or any embodiment thereof, the spiral separator comprises inclined plates for receiving suspended biomass that settle onto the plates at lower parts and form a coalesced sludge and wherein liquid effluent is removed through the liquid effluent outlet port.

According to another embodiment of the foregoing aspect or any embodiment thereof, when the bioreactor is in use, a treated wastewater passes up through a plate pack of the spiral separator and leaves the spiral separator via the outlet port, while the suspended biomass, which has settled on the plates at lower parts, coalesces and forms a sludge, whereby the sludge enters the reaction zone, thereby increasing a solids retention time (SRT) within the bioreactor.

According to another embodiment of the foregoing aspect or any embodiment thereof, the airlift configuration comprises two concentric tubes comprising an inner tube and an outer tube, and a moveable aerator mounted in the inner tube.

According to another embodiment of the foregoing aspect or any embodiment thereof, the aerator is for producing gas bubbles so that when the bioreactor is in use, the bubbles move upwardly into the inner tube and thereby drive a liquid circulation flow between the inner tube and an annular zone disposed between the inner tube and the outer tube.

In another aspect of the disclosure, there is provided a bioreactor according to the foregoing aspect or any embodiment thereof to treat a wastewater and obtain a treated and clear effluent therefrom.

In another aspect of the disclosure, there is provided a spiral separator for use in a bioreactor, the spiral separator being rotatable and comprising a series of plates for receiving suspended biomass and to form an aggregated sludge at the lower part thereon wherein the spiral separator is configured so that, when in operation, a treated wastewater passes up through a plate pack of the spiral separator and leaves the spiral separator via an outlet port of the bioreactor, while suspended biomass, which has settled on the plates at the lower part, coalesces and forms a sludge and wherein an excess amount of the sludge is removed via a sludge wasting pump.

In another aspect, there is provided a system comprising a bioreactor as described in any aspect or embodiment thereof, further comprising a membrane separator module for further purifying the liquid effluent.

In one embodiment, the membrane separator module may be an ultrafiltration membrane in a cross-flow membrane configuration to produce a clarified liquid effluent with high quality in a cost effective way.

### BRIEF DESCRIPTION OF THE DRAWINGS

A description of this invention provided in the following section present the features and advantages of this invention with reference to the following figures:

FIG. 1 is block diagram of the bioreactor of certain embodiments.

FIG. 2 is the schematic diagram of the bioreactor of certain embodiments.

FIG. 3 is a 3-dimensional view of the bioreactor.

FIGS. 4A and 4B illustrate a spiral separator of certain embodiments for use in the bioreactor showing different views.

FIG. 5 is a lab scale experimental unit of the bioreactor.

Other objects, features, and advantages of the present disclosure will be apparent to those of skill in the art from the following detailed description and figures.

### DETAILED DESCRIPTION

Embodiments presented herein include a novel hybrid airlift bioreactor equipped with an internal rotatable settling device with continuous operation for treating wastewaters containing pollutants such as refractory substances. By “airlift”, it is meant aeration is introduced to the bioreactor and provides a motive force to circulate the reactor contents, such as described in non-limiting examples herein. The terms “reactor” and “bioreactor” are used interchangeably and are not limited to the treatment of any particular kind of waste, and include reactors for treating both biological and non-biological waste, such as from the chemical industry.

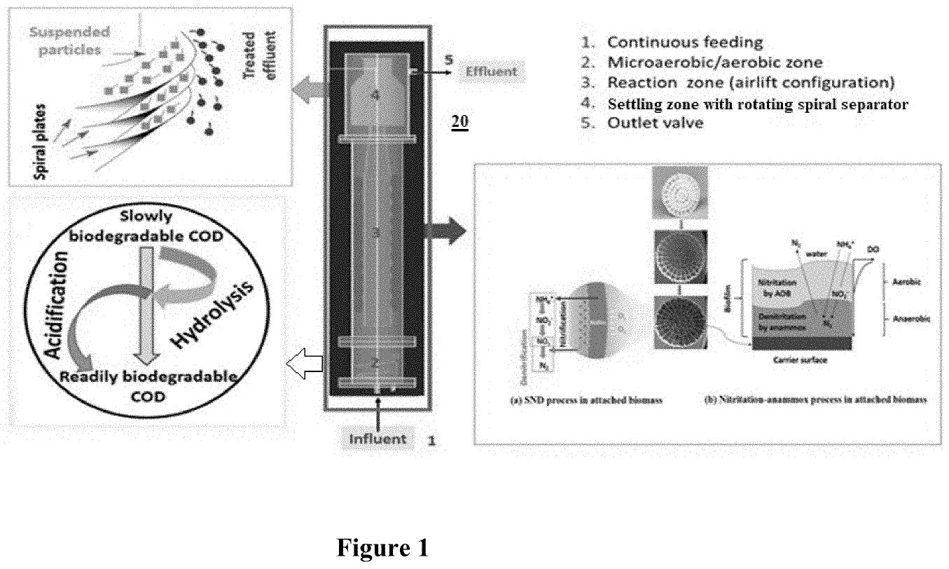

FIG. 1 depicts the overall design and function of the HALBR reactor 20 according to an embodiment of the disclosure. FIG. 1 also sets out various potential microbial processes in a pretreatment zone 2 and a reaction zone 3, as well as a general cross-sectional view of a spiral separator disposed in a settling zone 4.

The feed to the reactor 20, shown as an “influent”, is introduced to the reactor by a feeding port, which in this example is fed by a continuous feeding system 1. In the depicted example, the feeding port is located at the bottom of the reactor 20. The influent is a wastewater that requires treatment to produce a purer liquid effluent and solids removal. Microaerobic/anaerobic conditions are provided in the pretreatment zone 2 where the influent feed solution is continuously pumped (e.g., by a peristaltic pump or other suitable pump) by the continuous feeding system 1 into the pretreatment zone 2 via the feeding port. The anaerobic conditions at the bottom portion of the HALBR reactor can facilitate changes in the refractory complex micro-molecules into smaller molecules (solubilization) via hydrolysis and acidification. This is shown in the diagram to the left of the pretreatment zone 2 depicting biodegrading reactions of acidification and hydrolysis to produce readily biodegradable COD.

The reaction zone 3 in the example depicted operates in an airlift configuration. In particular, the reaction zone 3 described comprises two concentric tubes, and a moveable aerator that is mounted in the inner tube. When the reactor 20 is in operation, gas bubbles from the aerator move upwardly into the inner tube and drive a liquid circulation flow between the inner tube and an annular zone disposed between the inner tube and an outer tube. Biofilm carriers may be employed in some embodiments at one or more fixed positions within the downcomer for biofilm attachment. In certain embodiments, this may prolong the sludge (solids) retention time (SRT) and provide suitable conditions for the growth of different microbial populations to facilitate SND and anammox nitrogen removal.

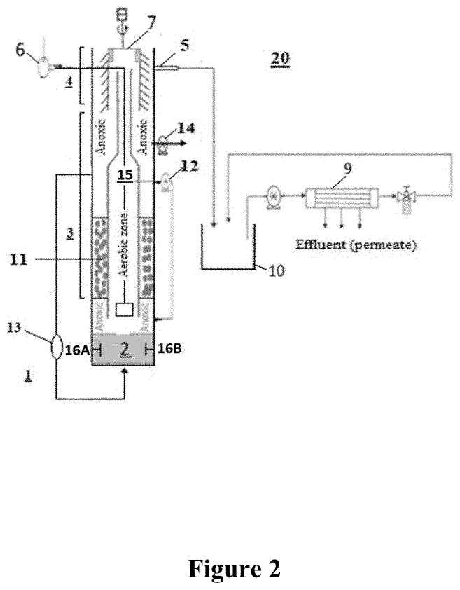

For the purpose of withholding the suspended biomass (solids) in the reactor 20 within the settling zone 4, there is provided a rotating spiral separator 7. FIG. 1 depicts pictorially how suspended biomass are separated in the settling zone (see inset at the left of the settling zone 4). As shown, the spiral separator 7 has a series of spiral plates (e.g., a plate pack) and suspended biomass settle on the plates, while treated effluent is separated therefrom during rotation of the spiral separator 7. The spiral separator 7 configuration is shown in more detail hereinafter (see FIGS. 2-5). The spiral separator 7 is disposed in the upper part of the riser area of the reactor 20 and functions to provide a separated liquid effluent that is of significantly better quality than that of conventional systems.

In particular, the treated effluent entering the spiral separator 7 flows along an inlet pipe and down the central core, which acts as a baffle, before flowing up through the plate pack. As described, suspended solids (SS) which are heavier than the liquid portion of the wastewater (e.g., dirty water), settle onto the plates. The treated wastewater passes up through the plate pack and leaves the separator 7 via its liquid effluent outlet port, while suspended biomass, which have settled onto the plates, aggregate and form a coalesced sludge The accumulated sludge then slide down the plates to an annular gap between the plate pack and the reactor wall and subsequently onto a lower portion of the bioreactor 20. The plate pack of the spiral separator 7 is rotated, which increases the relative velocity of settling particles on the plate and improves solids removal efficiency. The rotation also assists movement of the sludge off the plates and prevents the sludge from blocking the annulus.

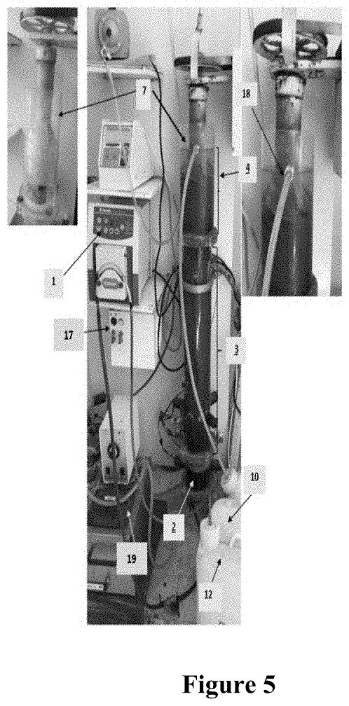

FIG. 2 shows the mechanical parts of a non-limiting example of the bioreactor 20 in more detail. As described previously, bioreactor 20 comprises a continuous feeding system 1 having a feeding pump 13 for introduction of an influent into the pretreatment zone 2 via a feeding port. Two side-mounted mixers 16A and 16B are depicted in the pretreatment zone 2 to enable adequate mixing therein. In some embodiments, favorable temperature (mesophilic condition) was achieved in the anaerobic mixed liquor by employing a heating element within the pretreatment zone 2 linked to a circulating water bath 23 (see FIG. 5 experimental set-up) to provide efficient mixing and maintain mesophilic conditions. The reaction zone 3 comprises packing media 11 in an annular space between the concentric tubes within aerobic zone 15 of the reactor zone 3. In this non-limiting example, the airlift configuration is provided by a recirculating pump 12, which facilitates circulation of a liquid stream within the reaction zone 3, and an air pump 6 introduces air into the aerobic zone 15. The settling zone 4 comprises the previously described rotating spiral separator 7 to separate the liquid effluent stream from the sludge. The liquid effluent is removed via a liquid effluent outlet port upon opening of an outlet valve 8, which in this example is disposed at the top of the reactor 20. A sludge wasting pump 14 is located beneath the settling zone 4 to withdraw sludge from the settling zone 4 via a solid outlet port. The solids outlet port depicted is not meant to be limiting and includes any suitable outlet from which solids can be withdrawn (e.g., sludge) from the bioreactor 20. Liquid effluent is fed in this example to an effluent tank 10. From the effluent tank 10, the liquid effluent can be subsequently fed to a membrane module 9 to produce a permeate of effluent that is composed of high-quality water (e.g., hygienic or substantially free of microbes or other contaminants). The membrane separation may be an ultrafiltration unit operating in a cross-flow configuration. A waste stream from the membrane separation is recirculated back to the effluent tank 10 as depicted.

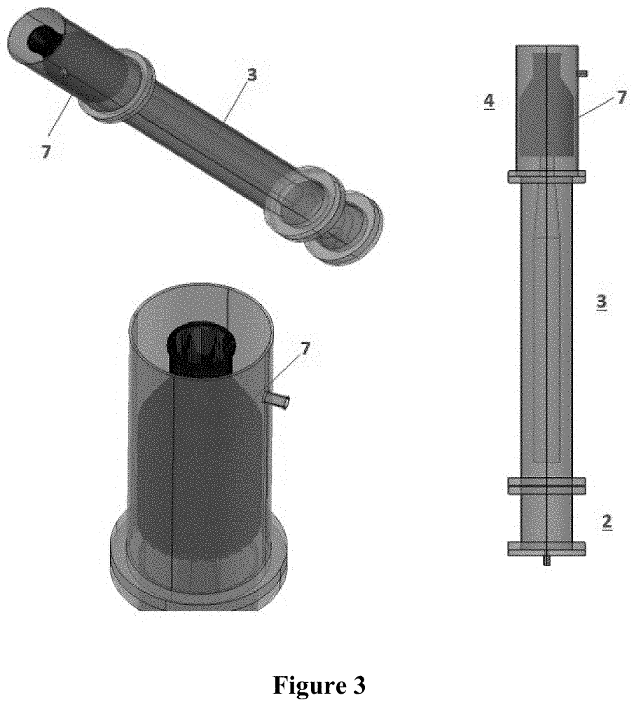

FIG. 3 depicts the 3D view of the bioreactor 20 using AUTOCAD 2019 software. Like references numbers depict the same reactor components between FIG. 3 and FIGS. 1 and 2 described previously. The bioreactor comprises an anaerobic pretreatment zone mounted at the lowest part 2 wherein the mesophilic (anaerobic/microaerobic) condition is provided to solubilize the slowly biodegradable part of COD. A vertical cylindrical steel draft tube is submerged in the main column discriminating the reaction zone 3 riser and down-comer. An internal settling zone 4 was incorporated at the top of the reaction zone to enable in situ separation of biomass suspension through a rotating spiral separator 7.

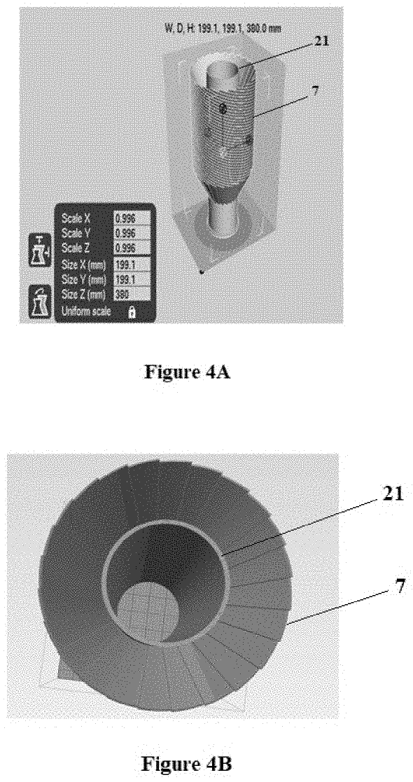

Referring to the in-situ sludge settling application of embodiments of the invention, in FIG. 3 and FIG. 4A and FIG. 4B, the spiral separator 7 of the settling zone 4 is shown in different views. The rotating spiral separator 7 comprises six inclined plates with the distance between each plate being 0.5 and 0.8 cm for R1 and R2, respectively with a slope of 35°. The inner tube passes through the central core 21 of the settling device 7 at the upper part of the riser area. The effluent flows along the inlet pipe and down the central core which acts as a baffle before flowing up through the plate pack. Suspended solids (SS) and/or particles, which are heavier than the dirty water, settle onto the plates. Settled, clarified water that is substantially free of the suspended solids passes up through the plate pack and leaves the separator via the liquid effluent outlet port (e.g., shown here as an outlet launder), while solids, which have settled on the plates, coalesce and form a sludge. The sludge then slides down the plates to the annular gap between the plate pack and the reactor wall and subsequently moves to a lower region of the reactor. The plate pack is continuously rotated, which increases the relative velocity of settling particles on the plate and improves solids removal efficiency. The rotation also assists movement of the sludge off the plates and stops sludge from blocking the annulus. Further, gentle shearing action in the annulus may contribute to the sludge thickening.

The embodiment of the invention described above and depicted in FIGS. 1-4 can be used for treatment of any material that requires purification, such as domestic sewage, landfill leachate, and a wide range of wastewaters from municipal to industrial containing refractory pollutants with a relatively low BOD/COD and high ammonia concentration (low COD/N). Preliminary test results for treating diluted composting leachate indicated that the invented hybrid bioreactor is capable of removing more than 90% of COD (4000 mg/L), more than 80% of TKN (610 mg/L) and TN (740 mg/L) with an effluent nitrate and turbidity of less than 3 mg/L and 100 NTU (with regard to a feed with a turbidity more than 600 NTU). The results were obtained using R2 at HRT of 18-30 h, air flow rate of 1-2 Lair/min, and AVR (aerobic volume ratio) of 0.22-0.26.

The embodiment described above can be operated as a membrane bioreactor and therefore is capable of producing hygienic water from high strength industrial wastewaters. In this regard, the treated effluent from the spiral separator continuously goes through an ultrafiltration anti-bacterial modified membrane in a cross-flow membrane set-up to produce hygienic water.

The advantages of the present invention may include simultaneous high-rate removal of organics and nutrients in a single bioreactor, highly efficient in situ sludge separation, and a significant lower treatment cost. The capability of the HALBR to be coupled with a cross-flow membrane set-up also provides the application of it as a membrane bioreactor to improve the quality of effluent and produce cost effective hygienic water from wastewater.

The HALBR reactor in some embodiments may include one or a combination of the following advantages:
a) A high-performance treatment complying with regulations for various types of effluents: Effluent with wide variation in flow and/or load, effluent containing refractory organic compounds, effluent with low COD/N, municipal and a wide range of industrial effluents such as livestock, pharmaceutical, petrochemical, food processing, and leachate, etc. by merging multiple bioreactors in a novel single unit;
b) Highly efficient nitrogen removal: Possibility of different nitrogen removal pathways;
c) Small footprint: Eliminating the need for the secondary clarifier, smart single-stage design merging multiple bioreactors (anaerobic/anoxic/aerobic processes), primary and secondary treatment, easy to cover due to its compactness. Required area for the proposed HALBR is about 30%, 55%, and 55% of the conventional activated sludge, SBR, and MBR processes, respectively; and
d) Easy operation: The automated system operates continuously and does not require that the materials be washed: operations are therefore optimized.
e) Flexibility: Fixed hybrid cultures adapt themselves to high variations in load and therefore they are suitable for use in areas with seasonal fluctuation in load.
f) Easy on-site implementation and modularity: The bioreactor can be phased to accommodate changing flows. Rotating spiral separator (a compact gravimetry settlement device) with its unique design can be applied in different running wastewater treatment plants on site which results in economic benefits due to removing the need for second clarifier, keeping the sludge retention time (SRT) at relatively long time, and lower construction costs. The operation costs for HALBR are only 63%, 75%, and 45% of the conventional activated sludge, SBR, and MBR technologies respectively (per m³ of the given wastewater).
g) Effluent refinement: HALBR can be coupled with a variety of post treatment processes to produce cost-effective potable water from wastewater.

The bioreactor disclosed herein also enables suspended growth treatment plants to upgrade to the hybrid system (combined suspended attached/attached growth system) with a highly efficient internal settler (coupled clarifier) to improve the efficiency and capacity of the existing systems. This will ensure the in-situ separation of sludge from the effluent and prolong SRT.

### EXAMPLE

The following describes an experimental set-up of the HALBR reactor 20 as shown in FIG. 5. Two reactors (R₁ and R₂) were constructed of transparent Plexiglass™ with working volumes and diameter-to-height ratio of 7.5 and 35 L and 1:7, 1:5, respectively. As described previously, the combined reactor 20 is divided into three zones: the pretreatment zone 2, the reaction zone 3 and the clarifying or settling zone 4.

Microaerobic/anaerobic conditions are provided in the pretreatment zone 2 at the bottom of the HALBR experimental set-up with a volume of 1 L for R₁ and 4.6 L for R₂. A feed solution from feed tank 12 was continuously pumped by the continuous feeding system 1 (e.g. a peristaltic feeding as shown in the set-up) into the pretreatment zone 2 (e.g., microaerobic/anaerobic zone). Two mixers were installed in the anaerobic chamber of the pretreatment zone 2 and a temperature controller 23 (hot water recirculating set) connected to thermal belt plates (sheets) around the outer wall was installed to provide efficient mixing and temperature conditions (mesophilic condition) in the pretreatment zone 2, respectively.

The reaction zone 3 (airlift aerobic/anoxic region) comprises two concentric tubes, with an annular zone therebetween. A moveable aerator is mounted in the inner tube. When the reactor operates, the gas bubbles from the aerator move upward into the inner tube and drive the liquid circulation flow between the inner tube and the annular zone. The inner tube enables the liquid to move upward and is called a riser. The annular zone between the two tubes is referred to as a down-comer, and in which the liquid moves downward. Carriers Kaldnes K2 (10 mm in diameter, 10 mm wide, and specific area of 350 m²/m³) were threaded through a jute yarn, and the carrier media string was twisted and tightened around the inner tube for biofilm attachment to prolong the SRT and provide suitable conditions for the growth of different microbial populations required for SND and anammox nitrogen removal.

The top portion of the reactor comprises the spiral separator 7. For the purpose of withholding the activated sludge in the reactor, the rotating spiral separator 7 (a compact gravimetry settlement device) was placed at the upper part of the riser area within settling zone 4. Clarified, treated effluent 18 is shown at the top of the settling zone 4. The clarified effluent 18 is fed to the effluent holding tank 10.

The coupled clarifier is designed to provide for the in-situ separation of sludge from the effluent. Accordingly, in advantageous embodiments, the whole reactor can maintain a required SRT and accomplish the SND nitrogen removal to provide an effluent of better quality than that of conventional systems.

Test results for treating diluted composting leachate and dairy wastewaters indicated that HALBR is capable of removing more than 90% of COD (4000 mg/L(composting leachate, R2) and 1000 mg/L (dairy wastewater, R1)) and over 80% of total nitrogen (740 mg/L (composting leachate, R₂) and 260 mg/L (dairy ewastewater,R1)) with an effluent nitrate and turbidity of less than 3 mg/L and 100 NTU (composting leachate, R₂) and 8 mg/L and 10 NTU (dairy wastewater, R1), respectively.

While the foregoing written description and example of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

1-16 (canceled)

17. A method for treating wastewater in an anaerobic-anoxic-oxic single stage bioreactor comprising:
introducing the wastewater in a bottom region of the bioreactor via a feed port;
solubilizing organic macro-molecules in the wastewater by accommodating anaerobic and/or microaerobic microorganisms in a microaerobic and/or anaerobic pretreatment zone located at the bottom region of the bioreactor;
providing an airlift configuration in a reaction zone located in a middle region of the bioreactor via an aerator, and wherein the reaction zone is configured so that gas bubbles from the aerator move upwardly into an inner tube and cause a liquid circulation flow between the inner tube and an annular zone disposed between the inner and an outer tube;
treating wastewater exiting the pretreatment zone under anoxic and/or aerobic conditions in the reaction zone by microbial populations housed in the middle region of the bioreactor;
after a treated wastewater exists the pretreatment zone, separating suspended biomass in the treated wastewater from liquid effluent via a spiral separator having a central core in a settling zone at the top region of the bioreactor;
rotating the spiral separator and wherein the central core accommodates a downward flow of the treated effluent exiting the reaction zone;
allowing the settled biomass to coalesce into thickened sludge that can be removed via a solid removal port; and
removing the liquid effluent through a liquid outlet port.

18. The method of claim 17, wherein the wastewater that is selected from:
pharmaceutical, petrochemical, food processing, livestock, and composting leachate wastewater.

19. The method of claim 1, wherein the micro-molecules are solubilized into smaller molecules by the microorganism via a hydrolysis and/or acidification.

20. The method of claim 1, wherein the bioreactor comprises a second feeding port disposed in an anoxic part in the bottom region of the bioreactor to allow availability of substrate in the wastewater for microorganisms attached therein and for introducing anoxic conditions thereof.

21. The method of claim 1, wherein the bioreactor comprises different nitrogen removal pathways.

22. The method of claim 1, wherein when the bioreactor is in use, a treated wastewater passes up through a plate pack of the rotatable spiral separator and leaves the separator via the liquid outlet port, while the sludge enters the reaction zone, thereby increasing a solids retention time (SRT) within the bioreactor.

23. The method of claim 1, wherein the aerator is a moveable aerator mounted in the inner tube.

24. A single-stage anaerobic-anoxic-oxic bioreactor for wastewater treatment comprising:
a feeding pump for continuously introducing a feed of wastewater into a feed port of the bioreactor, the feeding port located at a bottom region of the bioreactor;
the feeding port in fluid communication with a pretreatment zone in the bottom region thereof for solubilizing micro molecules in the wastewater by accommodating anaerobic and/or microaerobic conditions;
an aerobic/anoxic condition in a middle region in liquid communication with the pretreatment zone when the bioreactor is in operation, wherein the reaction zone comprises two concentric inner and outer tubes, and an aerator mounted in the inner tube to provide an airlift configuration to the feed via the aerator; and wherein the reaction zone is configured so that when the reactor is in operation, gas bubbles from the aerator move upwardly into the inner tube and cause a liquid circulation flow between the inner tube and an annular zone disposed between the inner and the outer tube;
a settling zone in a top region for separating suspended biomass in the wastewater from liquid effluent, the settling zone comprising a rotatable spiral separator having a central core for accommodating a downward flow of a treated effluent exiting the reaction zone induced by the airlift configuration and a series of outwardly extending inclined plates arranged in a spiral configuration on which the suspended biomass coalesce into thickened sludge;
a liquid outlet port for withdrawing the liquid effluent; and
a sludge wasting pump for removing excess sludge via a solid outlet port.

25. The bioreactor of claim 24, wherein the bioreactor comprises a second feeding port disposed in an anoxic part in the bottom region of the bioreactor to allow availability of substrate for microrgani sins attached therein and for introducing anoxic conditions thereof.

26. The bioreactor of claim 24, wherein the bioreactor comprises different nitrogen removal pathways.

27. The bioreactor of claim 24, wherein when the bioreactor is in use, a treated wastewater passes up through a plate pack of the rotatable spiral separator and leaves the separator via the liquid outlet port, while the sludge enters the reaction zone, thereby increasing a solids retention time (SRT) within the bioreactor.

28. The bioreactor of claim 24, wherein the aerator is a moveable aerator mounted in the inner tube.

29. A system comprising the bioreactor of claim 24 and further comprising a membrane separator module for further purifying the liquid effluent.

30. The system of claim 29, wherein the membrane separator module is an ultrafiltration membrane in a crossflow membrane configuration to produce a clarified liquid effluent.
